(19) United States
(12) Patent Application Publication
(10) Pub. No.: US 2026/0097799 A1
(43) Pub. Date: Apr. 9, 2026

(54) Transport Pallet

(71) Applicant: SAFE Structure Designs, LLC, Las Vegas, NV (US)

(72) Inventor: John Buscema, New Port Richey, FL (US)

(73) Assignee: SAFE Structure Designs, LLC, Las Vegas, NV (US)

(21) Appl. No.: 19/354,783

(22) Filed: Oct. 9, 2025

Related U.S. Application Data
(60) Provisional application No. 63/705,504, filed on Oct. 9, 2024.

(51) Int. Cl. B62B 3/00; B62B 5/00

(52) U.S. Cl. CPC B62B 3/001; B62B 5/0003; B62B 2301/044

(57) ABSTRACT

A transport pallet comprises a body having a first surface, an opposing second surface and a plurality of side surfaces; and a plurality of internal support structures arranged in spaced-apart columns and disposed between the first surface and the second surface. At least one side surface of the plurality of side surfaces includes at least one opening, and adjacent columns of the spaced-apart columns are separated by a gap in communication with the at least one opening.

### FIELD OF THE DISCLOSURE

The present disclosure relates generally to transport pallets and, more specifically, to a transport pallet with removable accessories and a corrugated core with a predetermined configuration and arrangements.

### BACKGROUND

Transport pallets facilitate efficient and secure transportation of goods, supplies, cargos, commodities, or other items. Such transport pallets may be used in a variety of industries, such as logistics, supply chains, manufacturing, E-commerce, the aviation industry, and the maritime industry.

Currently, conventional transport pallets (specifically in the aviation and maritime industries) often use wooden cores, for example Balsa wood cores, which may be heavy, provide limited tolerance to physical impact, or unideal for humid or marine environments. Upon exposure to water, the wooden core may swell significantly, which may compromise the functionality of supporting items to be transported.

Furthermore, conventional transport pallets are often transported by using specialized equipment, such as forklifts, cargo loaders, pallet jacks, trolleys, and so forth, which requires an additional operating procedure and inexperienced operators may mishandle the equipment. Moreover, such specialized equipment for relocating the transport pallets takes up a great amount of space for storage, and certain maintenance may be necessary.

### SUMMARY OF THE DISCLOSURE

The following is a concise summary of the present disclosure presented herein with the primary aim of providing a preliminary understanding of certain aspects of the present disclosure. It should be noted, however, that this summary is not intended to serve as a comprehensive overview of the present disclosure, nor does it seek to identify or describe any critical or significant elements of the present disclosure or the boundaries of its scope. Its sole purpose is to provide a rudimentary understanding of the present disclosure 's concepts and features, which will be expounded upon in greater detail in the ensuing sections.

In some embodiments, a transport pallet comprises a body having a first surface, an opposing second surface and a plurality of side surfaces; and a plurality of internal support structures arranged in spaced-apart columns and disposed between the first surface and the second surface. At least one side surface of the plurality of side surfaces includes at least one opening, and adjacent columns of the spaced-apart columns are separated by a gap in communication with the at least one opening.

In some embodiments, a transport pallet comprises a body and a plurality of internal support structures. The body comprises at least one top plate, an opposing bottom plate, and a plurality of frames forming boundaries to couple the at least one top plate to the bottom plate. At least one of the plurality of frames comprises at least one opening. The plurality of internal support structures are arranged in spaced-apart rows and disposed between the at least one top plate and the bottom plate. Adjacent rows of the spaced apart rows are separated by a gap, and each of the plurality of spaced apart rows comprises a plurality of continuous ridges and grooves. The gap is in communication with the at least one opening.

The present disclosure pertains to a transport pallet having internal support structures that have predetermined configurations and arrangements. The internal support structures, preferably constructed of aluminum (though other materials may be used) advantageously provide a high strength-to-weight ratio and are suitable for diverse environments. In addition, the predetermined arrangements include at least one gap that provides access for forklifts tines to engage the core of the transport pallet for lifting.

In addition, the transport pallet features a plurality of quick-release accessories that may be advantageously attached and detached to and from a body of the transport pallet effortlessly and efficiently. In circumstances where specialized equipment to handle the transport pallet is not available, accessories such as casters and tow bars may be promptly and easily attached to transport pallet for transportation.

The disclosed transport pallet comprises a durable and lightweight core with specific configurations and arrangements providing a high strength-to-weight ratio and suitable for diverse environments. In addition, the disclosed transport pallet comprises removable accessories such as wheels and towbars that are easy to attach and detach, which is not only convenient, but also increases efficiency in transportation.

The above features and advantages will become apparent from the following detailed description taken with the accompanying drawings.

### BRIEF DESCRIPTION OF DRAWINGS

FIG. 1 illustrates a front perspective view of a first non-limiting exemplary embodiment (the “first exemplary embodiment”) of a transport pallet.

FIG. 2 illustrates a bottom perspective view of the transport pallet of FIG. 1.

FIG. 3 illustrates a partially enlarged view of the transport pallet of FIG. 1 showing a track.

FIG. 4 illustrates a first explosive view of the transport pallet of FIG. 1.

FIG. 5 illustrates a second explosive view of the transport pallet of FIG. 1.

FIG. 6 illustrates an explosive view of a body of the transport pallet of FIG. 1, omitting two top plates and a bottom plate.

FIG. 7 illustrates an enlarged view and a partially explosive view of a caster of the transport pallet of FIG. 1.

FIG. 8 illustrates a perspective view of a tow bar of the transport pallet of FIG. 1 in a folded mode.

FIG. 9 illustrates a front perspective view of a second non-limiting exemplary embodiment (the “second exemplary embodiment”) of a transport pallet with fastening joints coupling casters and a tow bar in a first arrangement.

FIG. 10 illustrates an explosive view of a body of the transport pallet of FIG. 9.

FIG. 11 illustrates a partially enlarged view of FIG. 10.

FIG. 12 illustrates a first perspective view of one of the fastening joint of the transport pallet of FIG. 9.

FIG. 13 illustrates a second perspective view of the fastening joint of the transport pallet of FIG. 9.

FIG. 14 illustrates a first partially explosive view of the fastening joint of the transport pallet of FIG. 9.

FIG. 15 illustrates a second partially explosive view of the fastening joint of the transport pallet of FIG. 9.

FIG. 16 illustrates the fastening joint and a frame of the transport pallet of FIG. 9.

FIG. 17 illustrates a partially enlarged view of the transport pallet of FIG. 9 showing the fastening joint securing a caster to the frame.

FIG. 18 illustrates cross sectional view taken along line 11-11 of FIG. 9

FIG. 19 illustrates a front perspective view of the second exemplary embodiment of the transport pallet with fastening joints coupling a plurality of casters and a tow bar in a second arrangement.

### NUMBERING REFERENCE

100 – Transport Pallet

110 – Body

110a – First Surface

110b – Second Surface

110c – Side Surface

112 – Top plate

114 – Bottom Plate

116 – Frame

116a – First frame

116b – Second frame

116c – Third frame

122 – First Openings

124 – Second Opening

125 – Second Through Hole

126 – Notch

128 – Socket

130 – Track

132 – Bore

134 – Slot

140 – Ring

142 – Tab

150 – Internal Support Structures

150a – Column

150b – Row

152 – Ridge

154 – Groove

156 – Gap

158 – First Tube

159 – Pad

160 – Second Tube

162 – Aperture

164 – Support Tube

200 – Caster

202 – Caster Fastening Mechanism

204 – Wheel Assembly

206 – Mounting plate

208 – Protrusion

210 – First Through Hole

300 – Tow Bar

302 – Arm Segment

304 – Hinge

306 – Loop

308 –Tow Bar Fastening Mechanism

310 –Locking Mechanism

500 – Transport Pallet

510 – Body

510a – First Surface

510b – Second Surface

510c – Side Surface

512 – Top plate

514 – Bottom Plate

516 – Frame

516a – First frame

516b – Second frame

516c – Third frame

522 – First Openings

524 – Second Opening

530 – Track

532 – Bore

534 – Slot

550 – Internal Support Structures

550a – Column

550b – Row

552 – Ridge

554 – Groove

556 – Gap

558 – First Tube

559 – Pad

560 – Second Tube

570 – Upper Portion

572 – Lower Portion

574 – First Channel

576 – Second Channel

578 – Groove

600 – Fastening Joint

610 – First Member

611 – First Horizontal Part

612 – Stud

613 – Head

614 – Neck

615 – First Vertical Part

616 – Recess

617 – Lip

618 – Spring

620 – Second Member

621 – Second Horizontal Part

622 – Protrusion

623 – Second Vertical Part

630 – Connecting Member

631 – Rod

631a – First End

631b – Second End

632 – Annular Flange

633 – Lever

640 – Linking Member

700 – Caster

800 – Tow Bar

### DETAILED DESCRIPTION OF THE DISCLOSURE

The following detailed description and accompanying drawings provide a comprehensive disclosure of an exemplary embodiment for the purpose of facilitating one of ordinary skill in the relevant art to make and use the disclosure. As such, the detailed description and illustration of the one or more exemplary embodiments presented herein are purely exemplary in nature and are not intended to limit the scope of the disclosure or its protection in any matter. It is further noted that the drawings may not be to scale, and in some cases, certain details may be omitted which are not necessary for an understanding of the present disclosure, such as conventional details of fabrication and assembly. Furthermore, there is no intention to be bound by any expressed or implied theory presented in the preceding technical field, background, brief summary or the following detailed description.

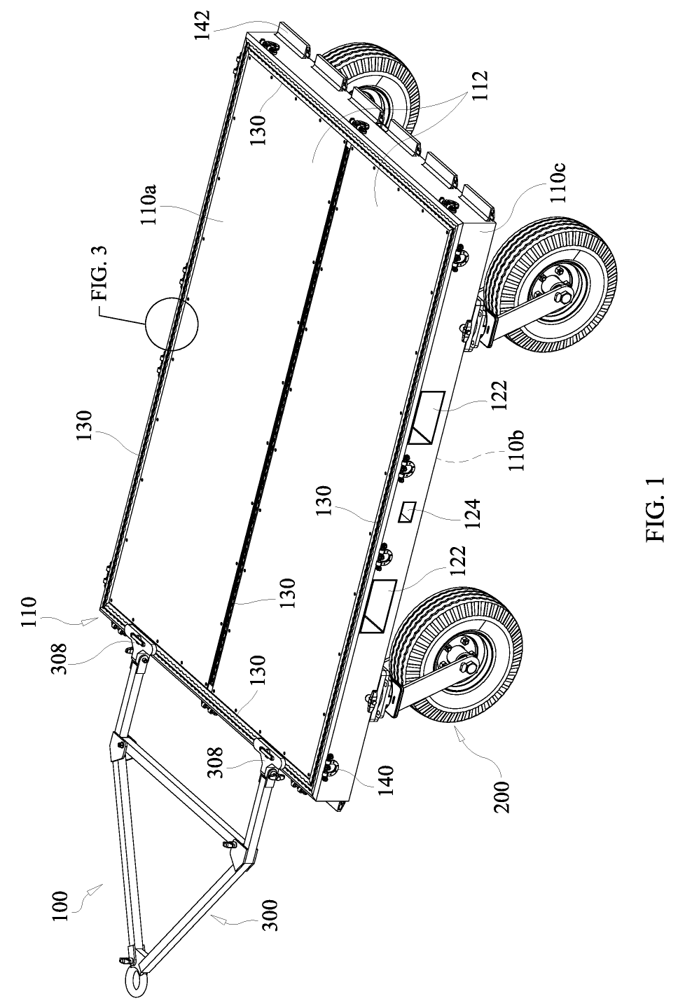

For purposes of description herein, various spatial terms, such as “top”, “bottom”, “front”, “rear”, “side”, “horizontal”, “vertical” and derivatives thereof may be used to describe relative positions of one element and another element with respect to the drawings and shall relate to the device as oriented in FIG. 1. However, it should be understood that these terms are not intended to be limiting or absolute.

A non-limiting, exemplary first embodiment (hereinafter as “the first exemplary embodiment”) of a transport pallet 100 is illustrated from FIGS. 1 to 8 and disclosed herein. The transport pallet 100 comprises corrugated internal support structures 150 having predetermined configurations and arrangements that are lightweight, suitable for diverse environments, and provide stable support for items placed on the transport pallet 100. In addition, the transport pallet 100 comprises at least one removable accessory that can be securely locked to or effortlessly detached from the transport pallet 100. The accessories may include, but are not limited to, a caster 200, a tow bar 300, a jack or other accessories applicable to the transport pallet 100.

FIG. 1 illustrates a front perspective view of the transport pallet 100 according to the first exemplary embodiment. As shown in FIG. 1, the transport pallet 100 comprises a body 110 having a substantially rectangular prism configuration with a first surface 110a, an opposing second surface 110b and four side surfaces 110c (although any suitable number of surfaces can be provided). The body 110 further comprises at least one top plate 112 (two of which are shown in FIG. 1 being positioned spaced apart and parallel to each other, although any suitable number of top plates is contemplated), a bottom plate 114 and a plurality of frames 116. The two top plates 112 are disposed on top ends of the frames 116 and the bottom plate 114 are disposed on bottom ends of the frames 116. Further, at least one track 130 (five of which are shown in FIG. 1, although any suitable number of tracks can be provided) is elongated and recessed on the first surface 110a of the body 110. In accordance with the first exemplary embodiment, four tracks 130 are positioned along the sides of the rectangular periphery, and one track 130 is positioned between the two top plates 112. The body 110 may further comprise a plurality of tabs 142 arranged on the side surfaces 110c for securing the body 110 to the floor of a vehicle (not shown). For example, the plurality of tabs 142 may be used with floor locks of an aircraft (not shown).

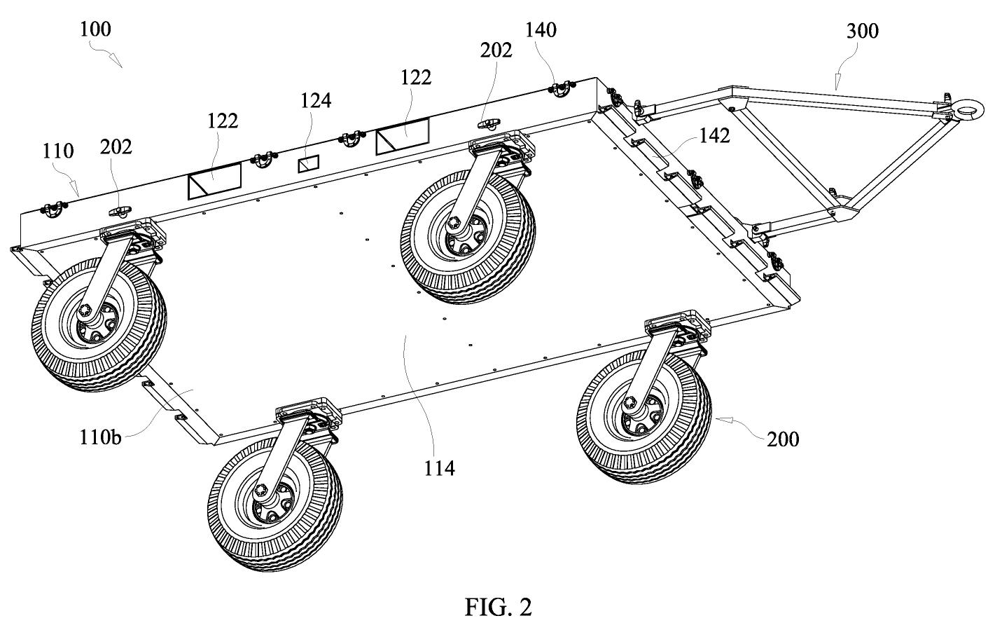

With continuing reference to FIG. 1, FIG. 2 illustrates a bottom perspective view of the transport pallet 100. The transport pallet 100 further comprises removable attachments, such as a plurality of casters 200, that are configured for coupling to the second surface 110b of the body 110, and a tow bar 300 that is configured for coupling to the at least one track 130. Each caster 200 of the plurality of casters 200 can include a caster fastening mechanism 202 that can be effortlessly attached to, and detached from, the body 110. Moreover, the tow bar 300 can include a tow bar fastening mechanism 308 that can be effortlessly attached to, and detached from, the body 110. In addition, a plurality of rings 140 (shown in FIGS. 1 and 2 as D-rings, although any suitable types of rings are contemplated) may be disposed on side surfaces of the frames 116. The rings 140 may serve as attachment points for straps (not shown) or nets (not shown) to secure items to the transport pallet 100 during transit.

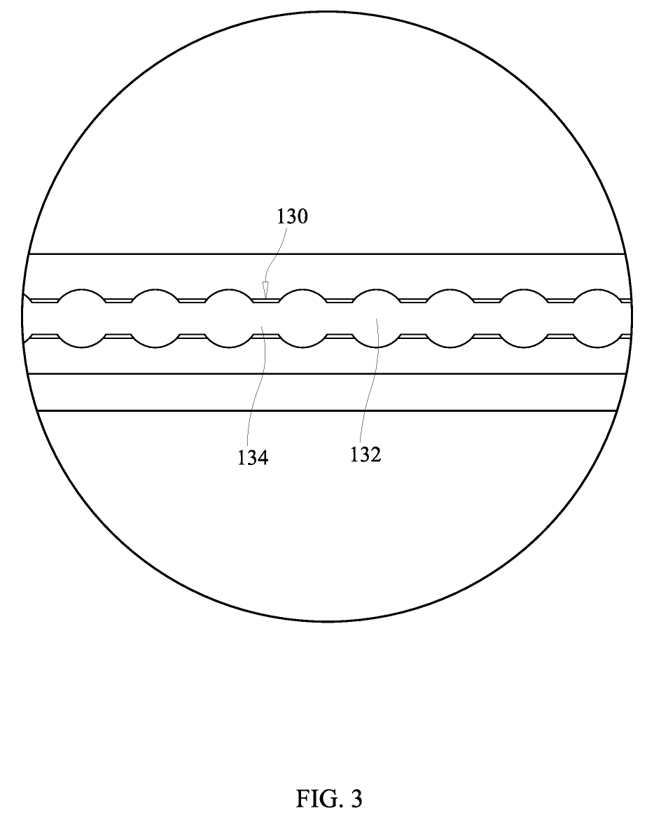

With continuing reference to FIG. 1, FIG. 3 shows an enlarged view of the at least one track 130. It is preferable that the at least one track 130 is a logistic track (L-track) comprising a plurality of bores 132 equally spaced apart and in communication with each other via an elongated slot 134. Preferably, diameters of each of the bores 132 are approximately equal to each other and are greater than a width of the elongated slot 134. It is preferable that each track 130 of the at least one track 130 comprises a continuous track. However, the track 130 may also be divided into segments. As shown in FIG. 1, the tow bar fastening mechanism 308 may be coupled to the at least one track 130. Here, it is shown that the tow bar 300 is attached to the track 130 that is on a width side of the body 110. However, the tow bar 300 alternatively can also be coupled to the track 130 on a length side of the body 110.

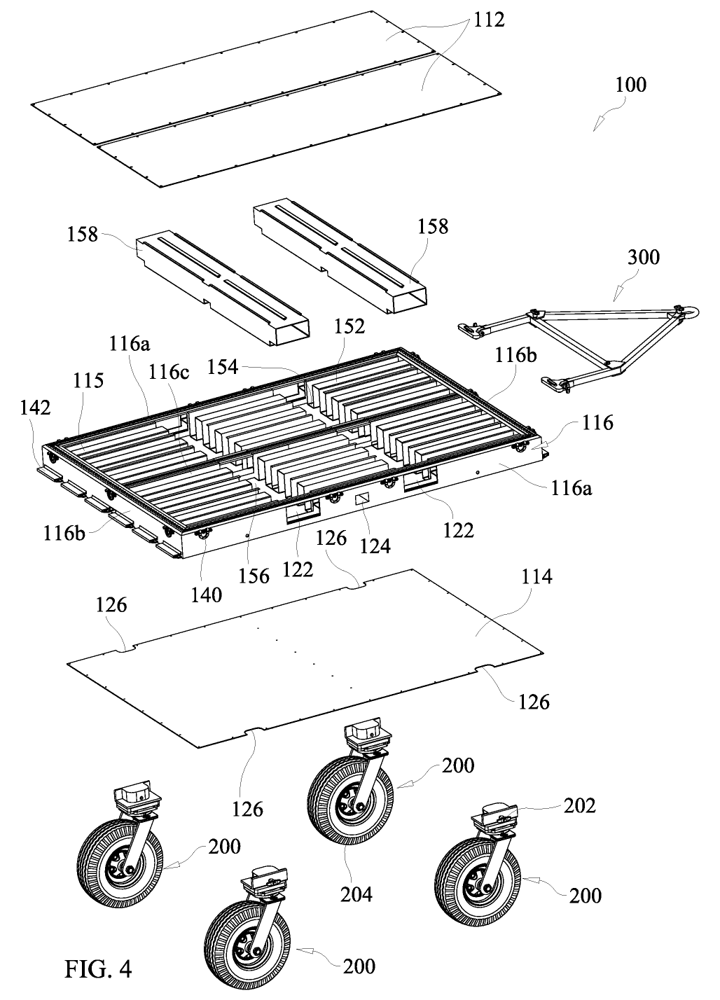

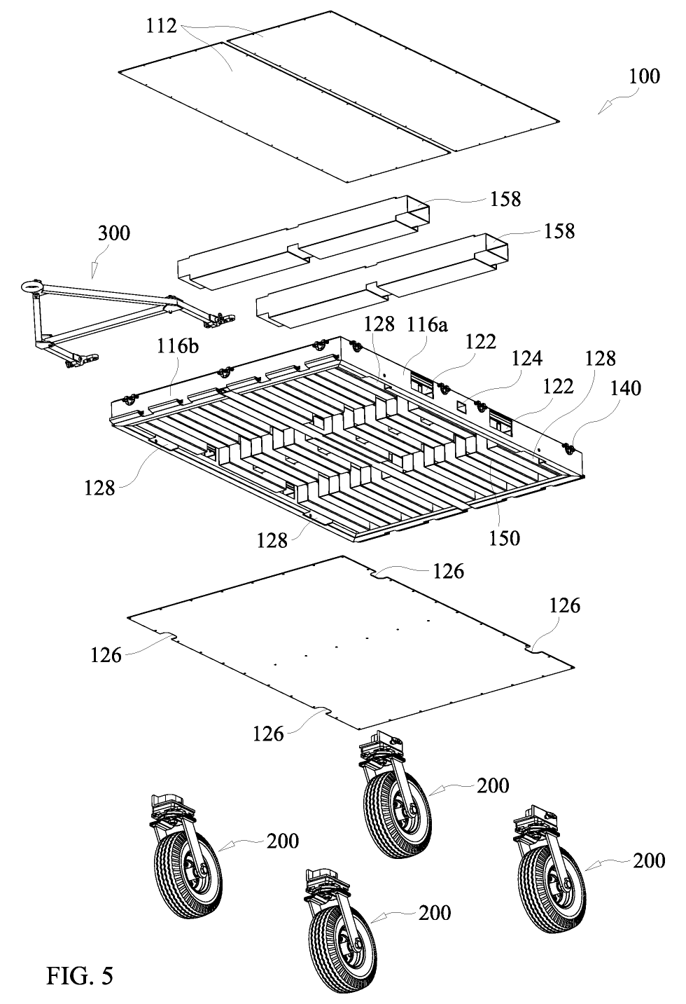

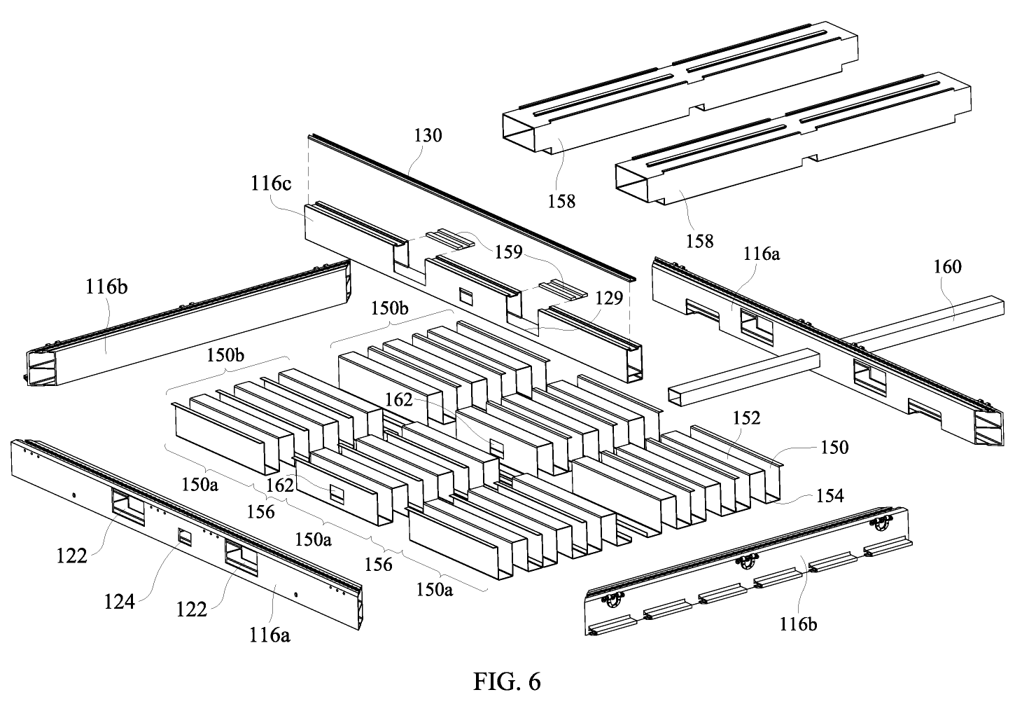

Referring now to FIGS. 4-6, FIGS. 4 and 5 illustrate two different explosive views according to the first exemplary embodiment, and FIG. 6 illustrates an explosive view of the body 110 with the two top plates 112 and the bottom plate 114 omitted. As shown in FIGS. 4 and 5, the frames 116 further comprise parallelly positioned two first frames 116a and two second frames 116b coupled to the two first frames 116a to form a rectangular periphery. A length of the first frame 116a is greater than a length of the second frame 116b. A third frame 116c (best shown in FIG. 6) is positioned to divide the rectangular periphery along the second frame 116b. The two first frames 116a, the two second frames 116b and the third frame 116c form boundaries for coupling the two top plates 112 to the body 110.

Referring now to FIG. 6, four of the tracks 130 are positioned on the each of first and second frames 116a, 116b. The body 110 further comprises a plurality of internal support structures 150 positioned between the two top plates 112 and the bottom plate 114 to strengthen a structural integrity of the transport pallet 110 when bearing heavy loads. The plurality of internal support structures 150 are aligned in a grid with a plurality of columns 150a and rows 150b. Each support structure 150 further comprises a plurality of continuous ridges 152 and grooves 154. The columns 150a are positioned spaced apart forming at least one gap 156 (FIG. 6 shows three columns of internal support structures and two gaps, although any suitable number of rows and gaps may be provided). Two cutouts 129 are formed on the third frame 116c. In addition, two first tubes 158 (preferably having rectangular cross-sections, although any suitable configuration may be provided) are positioned within the two cutouts 129 of the third frame 116c and along the gaps 156. Next, two pads 159 are disposed upon the two first tubes 158. Top surfaces of the third frame 116c and the pads 159 are recessed to receive one of the tracks 130 of the at least one track 130. In addition, two first openings 122 are defined on each of the two first frames 116a to align with both ends of the first tubes 158. Advantageously, forklifts tines (not shown) may be inserted into the two first tubes 158 for lifting the transport pallet 100.

In accordance with the first exemplary embodiment, the internal support structures 150 are divided by the third frame 116c to form two sets of rows 150b. Further, the grooves and ridges 152, 154 have rectangular configurations with a length parallel to the first frame 116a. The middle column 150a of the internal support structures 150 further comprises a plurality of identical apertures 162 aligned with each other. The apertures 162 are configured to receive a second tube 160. In some particular embodiments, the internal support structures 150 are constructed with light weight metal, such as rolled form aluminum sheets. In some particular embodiments, the internal support structures 150 may be a plurality of folded metal parts or metal extrusions combined to form the columns 150a and the rows 150b. However, it is anticipated that the configurations and material of the plurality of corrugation supports 116 may vary. Further, at least one second opening 124 is defined on at least one of the two second first frames 116a to align with at least one end of the second tube 160. In some embodiments, the at least one second opening 124 is configured to receive a portion of the second tube 160.

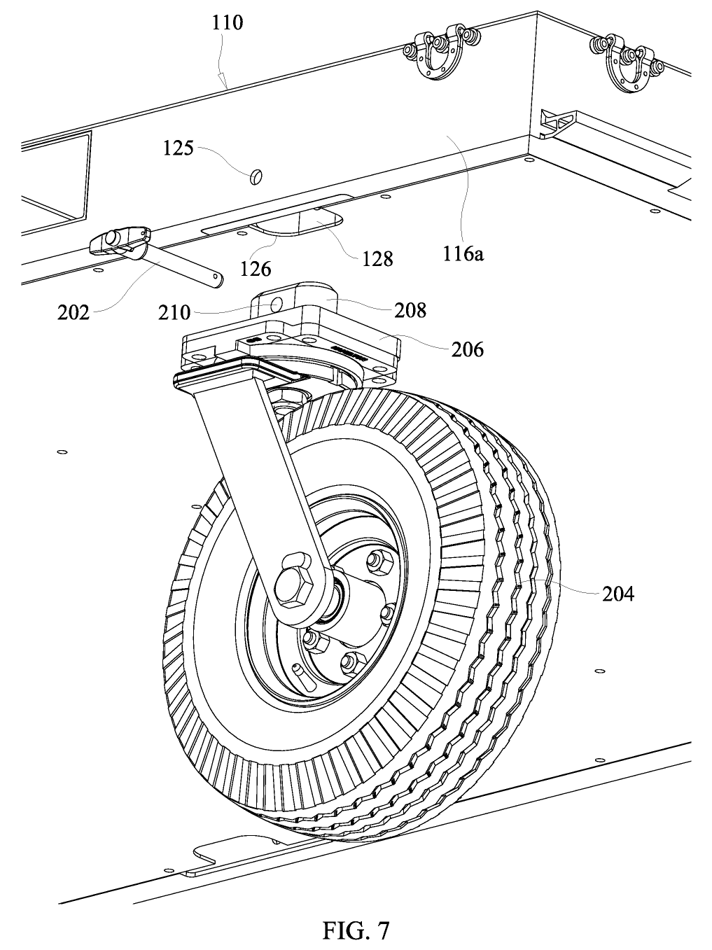

With continuing reference to FIGS. 4 to 5, FIG. 7 shows an enlarged view and partially exploded view of the transport pallet 100 showing how the casters 200 are attached to the body 110. As shown in FIG. 5, the first frames 116a further comprise a plurality of sockets 128 (four of which are shown, although any number of sockets can be provided) positioned adjacent to four corners of the rectangular periphery. Four notches 126 are indented from edges of the bottom plate 114 to align with the four sockets 128. Turning to FIG. 7, the caster 200 further comprises the caster locking mechanism 202, a wheel assembly 204, and a mounting plate 206. The wheel assembly 204 is coupled to a bottom surface of the mounting plate 206, and a protrusion 208 corresponding to the socket 128 is formed upon a top surface of the mounting plate 206. The protrusion 208 further comprises a first through hole 210 boring through a side surface thereof. A second through hole 125 disposed through the first frame 116a and is in communication with the socket 128. The second through hole 125 is configured for alignment with the first through hole 210. The caster fastening mechanism 202 passes through the aligned first and second through holes 125, 210 to locks the caster 200 in place with the first frame 116a. Advantageously, the caster 200 can be attached and detached to and from the body 110 efficiently and effortlessly.

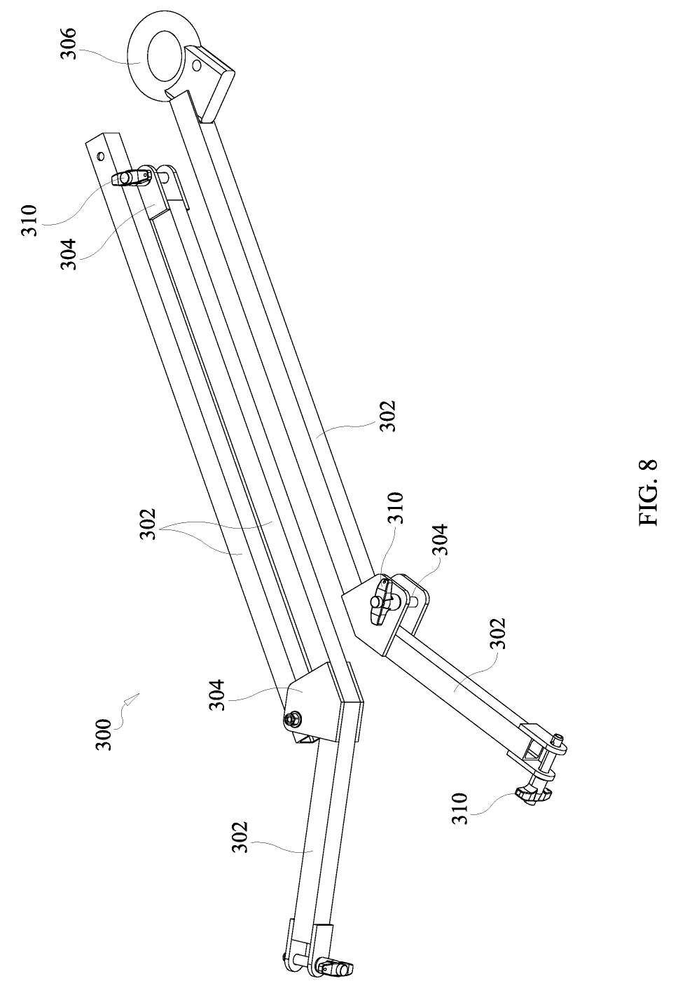

With continuing reference to FIG. 1, FIG. 8 illustrates the tow bar 300 in a folded/disassembled form (contrary to an expanded/assembled form shown in FIG. 1). The tow bar 300 further comprises a plurality of arm segments 302 connected by hinges 304 that allow for folding and optional disassembly of the tow bar 300 for easy storage. As shown in FIG. 8, one of the hinges 304 comprises a loop 306 for attachment to ground support equipment or vehicles for moving the transport pallet 100. In accordance with the first exemplary embodiment as shown in FIG. 1, the tow bar 300 comprises five arm segments 302, three of which form a triangle and two of which parallelly extend from two vertices of the triangle and are connected to one of the frames 116 of the body 110 by the tow bar fastening mechanism 308. Turning to FIG. 8, the tow bar 300 may be disassembled into two separate pieces, and the hinges 304 may comprise a plurality of locking mechanisms 310 configured to restrict rotation of the arm segments 302. Advantageously, the tow bar 300 can be attached and detached to and from the body 110 efficiently and effortlessly.

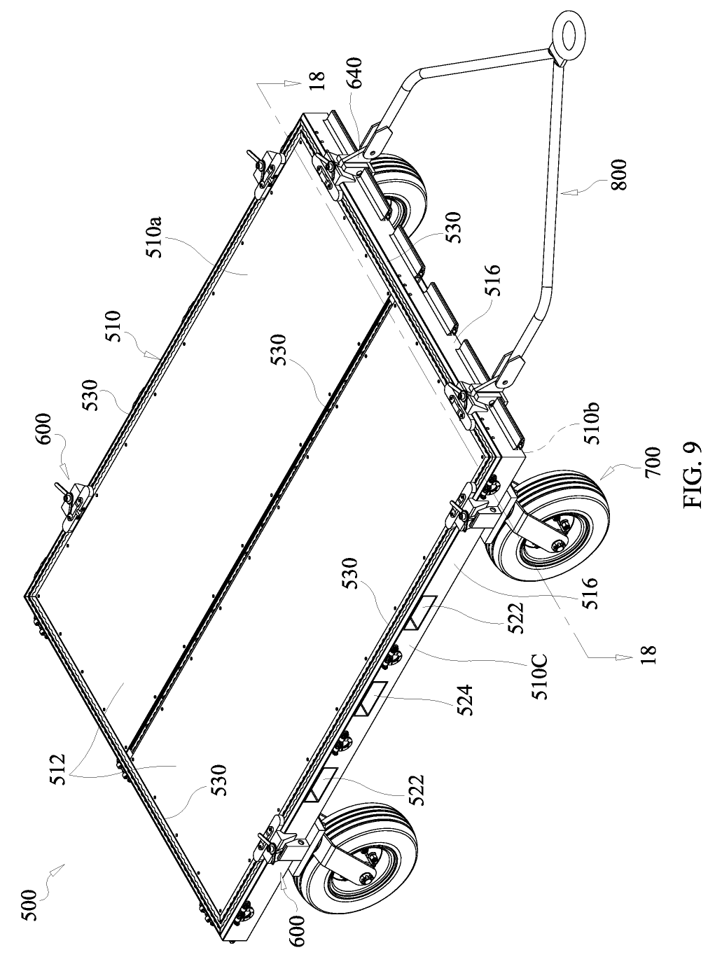

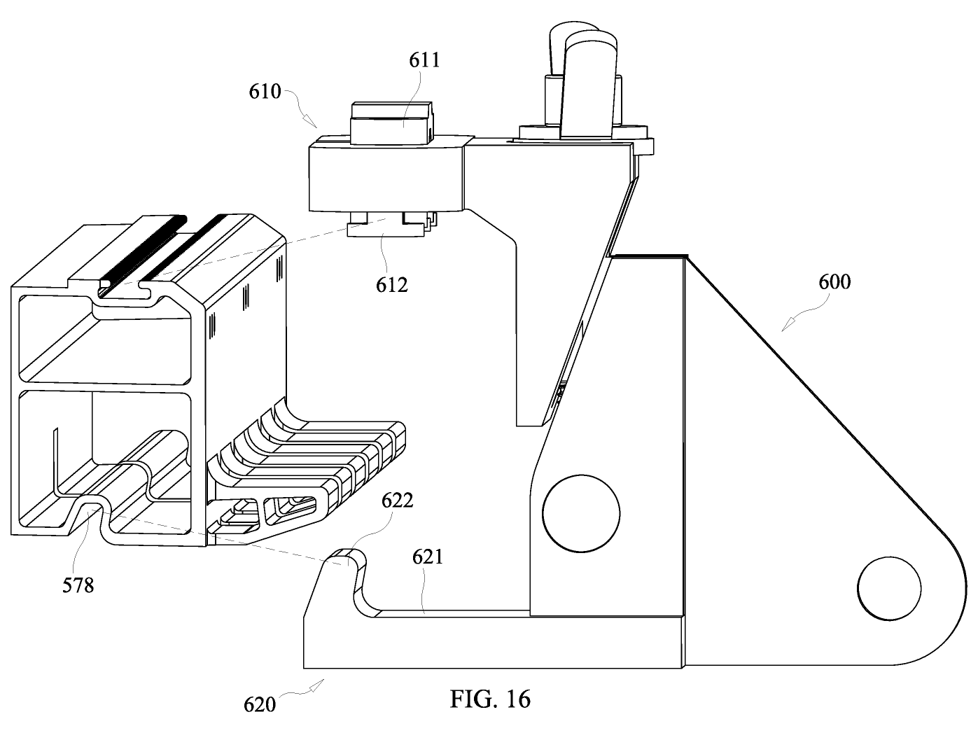

A non-limiting, exemplary second embodiment (hereinafter as “the second exemplary embodiment”) of a transport pallet 500 is illustrated from FIGS. 9 to 19. As shown in FIG. 9, the transport pallet 500 comprises at least one removable fastening joint 600 which may be applied with a variety of accessories to securely lock them to the transport pallet 500. The fastening joint 600 may couple or uncouple the variety of accessories effortlessly to or from the transport pallet 500. The accessories may include, but are not limited to casters 700, a tow bar 800, a jack or other accessories applicable to the transport pallet 500.

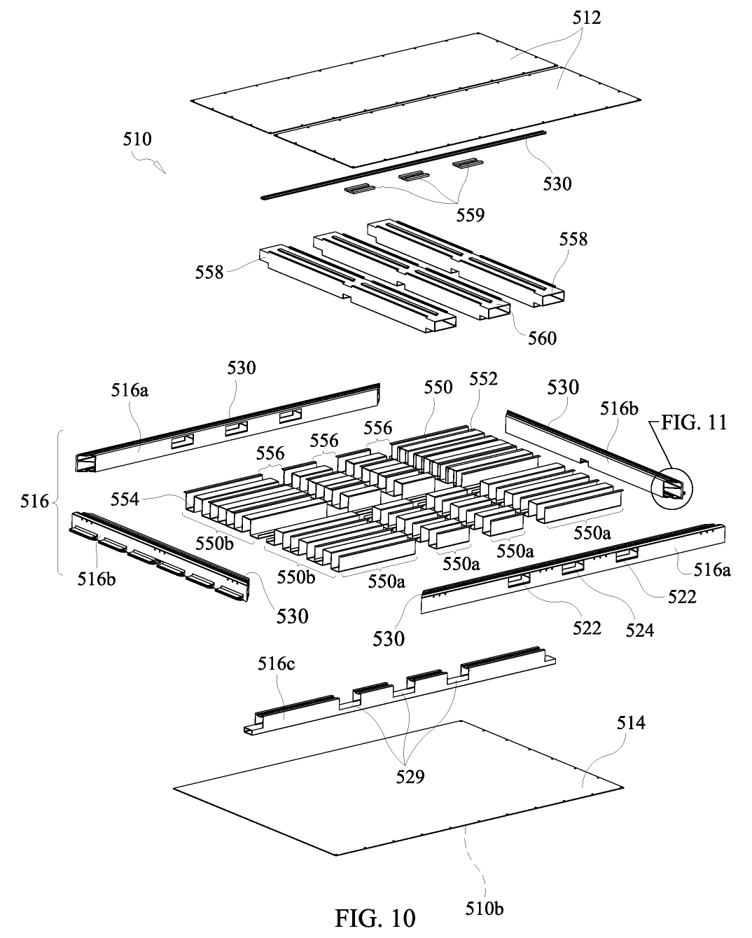

Referring now to FIGS. 9 to 10, FIG. 9 illustrates a front perspective view of the second exemplary embodiment, and FIG. 10 is a partially exploded view of FIG. 9. Similar to the first exemplary embodiment, the transport pallet 500 includes a body 510 with a substantially rectangular prism configuration with a first surface 510a, an opposing second surface 510b and four side surfaces 510c (although any suitable number of surfaces can be provided). The body 510 further comprises at least one top plate 512 (two of which are shown in FIG. 9 being positioned spaced apart and parallel to each other, although any suitable number of top plates is contemplated), a bottom plate 514 (FIG. 10) and a plurality of frames 516 (five of which are shown in FIG. 10, although any suitable number of frames can be provided). As shown in FIG. 10, the plurality of frames 516 further comprises two first frames 516a and two second frames 516b. The first frames 516a and the second frames 516b form a rectangular periphery coupling the two top plates 512 and the bottom plate 514. A third frame 516c (best shown in FIG. 10) is within the rectangular periphery, perpendicularly to the first frames 516a and parallel to the second frames 516b. The two first frames 516a, the two second frames 516b and the third frame 516c form boundaries for coupling the two top plates 512 thereto. Further, at least one track 530 (five of which are shown in FIG. 10, although any suitable number of tracks can be provided) is elongated and recessed on the first surface 510a of the body 510. In accordance with the second exemplary embodiment, four tracks 530 extend along the sides of the rectangular periphery, and one track 530 is positioned between the two top plates 512. As shown in FIG. 10, four of the tracks 530 are recessed on the two first and second frames 516a, 516b.

With continuing reference to FIG. 10, the body 510 further comprises a plurality of internal support structures 550 positioned between the two top plates 512 and the bottom plate 514 to strengthen the structural integrity of the transport pallet 110 when bearing heavy loads. The plurality of internal support structures 550 are aligned in a plurality of columns 550a and rows 550b. In accordance with the second exemplary embodiment, the internal support structure 550 are arranged in four columns 550a and are positioned spaced apart to form three gaps 556 , though any number of columns and gaps may be provided. The internal support structures 550 of the plurality of internal support structures 550 further comprises a plurality of continuous ridges 552 and grooves 554. The grooves 552 and ridges 554 each have rectangular configurations with a length parallel to the first frame 516a. In addition, three cutouts 529 are formed on the third frame 516c. Two first tubes 558 and a second tube 560 (preferably having rectangular cross-sections, although any suitable configuration may be provided) are positioned within the three cutouts 529 of the third frame 516a and along the three gaps 556. Here, the second tube 560 is positioned between the two first tubes 558. Next, a pad 559 is disposed upon each of the two first tubes 558 and the second tube 560. Top surfaces of the third frame 516c and the pads 559 are recessed to receive a corresponding one of the tracks 530. Further, two first openings 522 defined on each of the two first frames 516a are configured to align with both ends of the first tubes 158, and a second opening 524 defined between the two first openings 522 is configured to align with both ends of the second tube 560. Advantageously, forklifts tines (not shown) may be inserted into the two first tubes 558 for lifting the transport pallet 500.

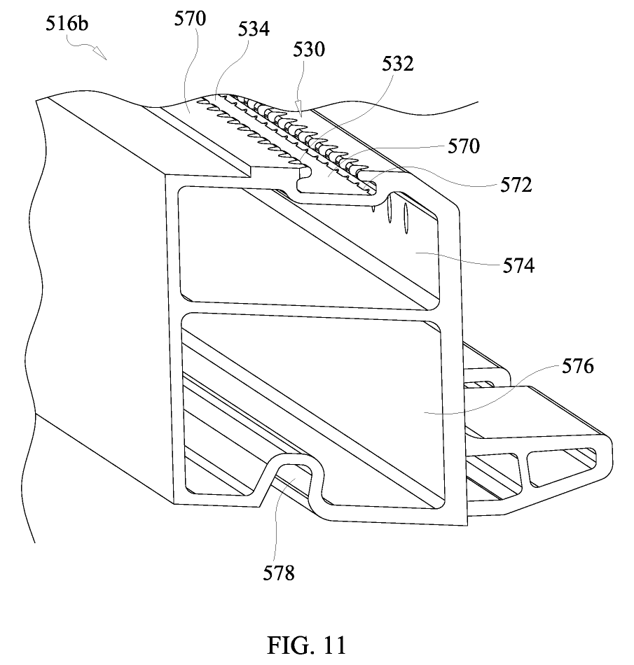

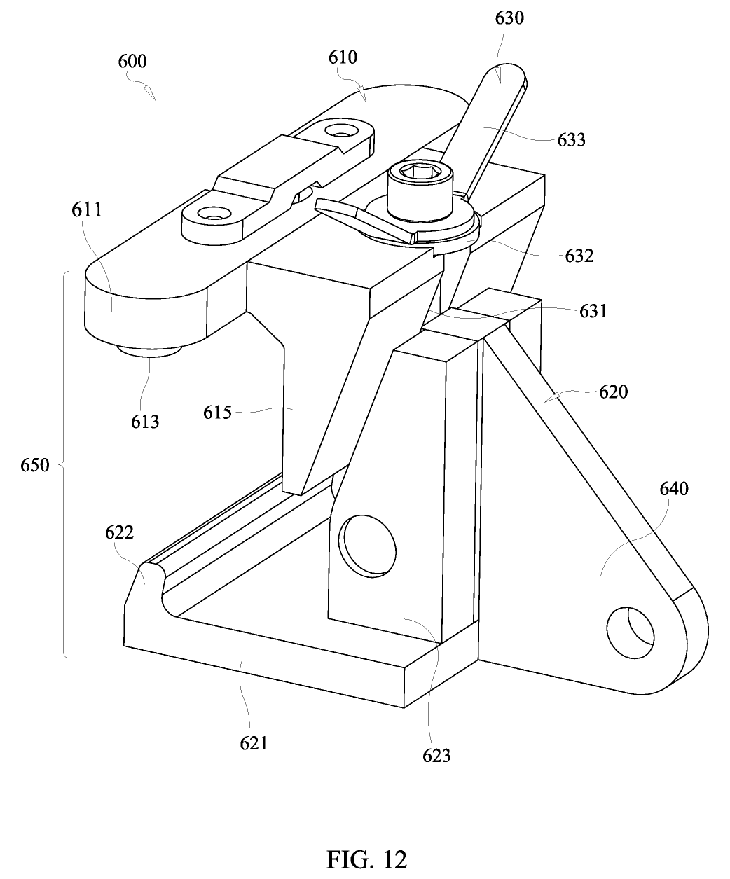

FIG. 11 is a partially enlarged view of the second frame 516b shown in FIG. 10. It is noted that the two first frames 516a have similar cross-sectional views, but are not shown in FIG. 11 for brevity and conciseness. Similar to the first exemplary embodiment (as shown in FIG. 3), the at least one track 530 is preferably an L-Track and further comprises a plurality of bores 532 equally spaced apart and in communication with an elongated slot 534. In the second exemplary embodiment, as shown in FIGS. 11 and 12, the second frame 516b further comprises a first channel 574 and a second channel 576 positioned below the first channel 574. The elongated slot 534 further comprises an upper portion 570 and a lower portion 572 below the upper portion 570. The lower portion 572 has a width greater than the upper portion 570 forming a substantially inverted T-shaped slot to receive a portion of the at least one removable fastening joint 600, as described in more detail below. On a bottom surface of the second channel 576, a groove 578 having a substantially U-shaped configuration with an asymmetrical profile extends along the second frame 516b. The groove 578 is configured to receive a portion of the at least one removable fastening joint 600, as described in more detail below. However, it is anticipated that the configuration of the groove 578 may vary.

Turning to FIGS. 12 to 15, the fastening joint 600 further comprises a first member 610, a second member 620, and a connecting member 630 coupling the first and second members 610, 620 together. It is anticipated that the first member 610, the second member 620 and the connecting member 630 may be one single part, two separate parts or three separate parts, without departing the spirit of the present disclosure. A tether (not shown) may be added to connect the separate parts. In some particular embodiments, the second member 620 may further comprise a lock (not shown) to restrict the connecting member 630 to move within a predetermined vertical distance, to prevent the connecting member 630 from detaching from the second member 620.

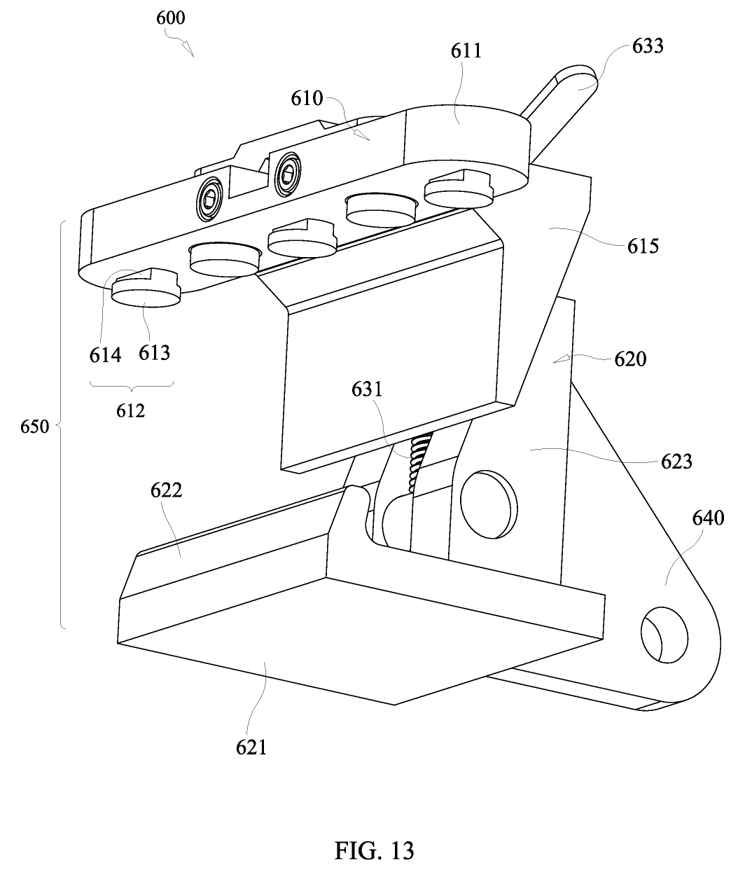

As best illustrated in FIGS. 12 to 13, the first member 610 further comprises a first horizontal part 611 and a first vertical part 615 coupled to the first horizontal part 611. The second member 620 further comprises a second horizontal part 621 and a second vertical part 623 coupled to the second horizontal part 621. The first horizontal part 611 of the first member 610 is parallel to the second horizontal part 621 of the second member 620, and the first vertical part 615 of the first member 610 is positioned adjacent to the second vertical part 623 of the second member 620, thereby forming a gripping area 650 configured to claw onto the frames 516 of the transport pallet 500. In accordance with the second exemplary embodiment, the first horizontal part 615 of the first member 610 is positioned in front of the second horizontal part 623 of the second member 620.

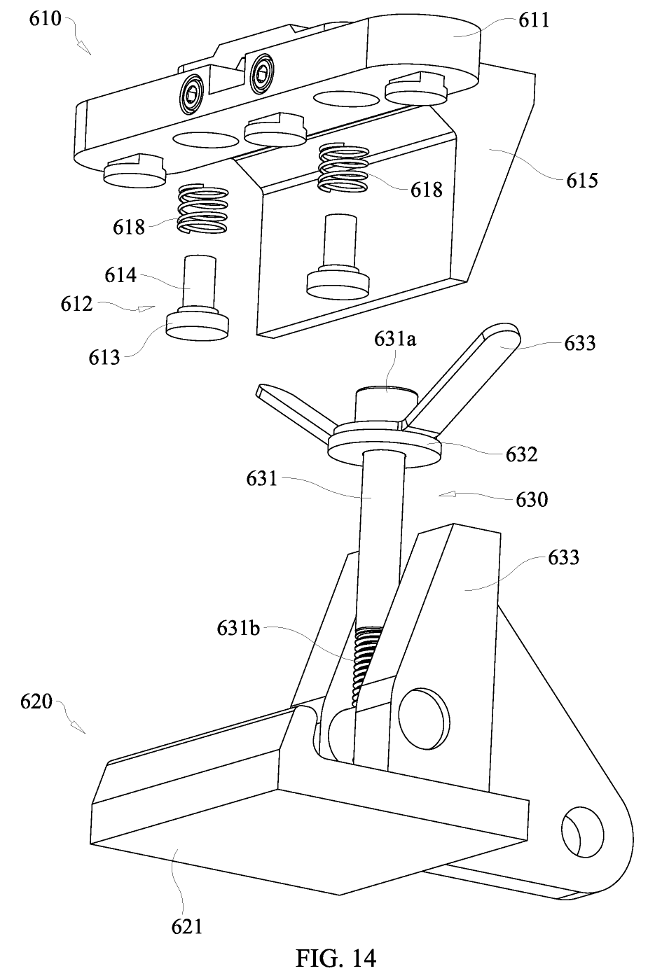

Referring to FIGS. 13 and 14, a plurality of circular studs 612 are positioned on a bottom surface of the first horizontal part 611 and extend towards the second horizontal part 621. Each stud 612 of the plurality of studs 612 may further comprise a head 613 and a neck 614 extending from the head 613. The neck 614 can have a diameter smaller than a diameter of the head 613. A spring 615 is positioned on the neck 614, such that the stud 612 is biased against the first horizontal part 611.

Continuing to refer to FIG. 14, the connecting member 630 further comprises a rod 631 having a first end 631a and a threaded second end 631b threadedly coupled to the second horizontal part 621 of the second member 620. The first end 631a further comprises an annular flange 632 having at least one lever 633 extend radially therefrom. It is also anticipated that the connecting member 630 may be in a different form, such as a latch or other fasteners, to increase or decrease a distance between the first and second member 610, 620.

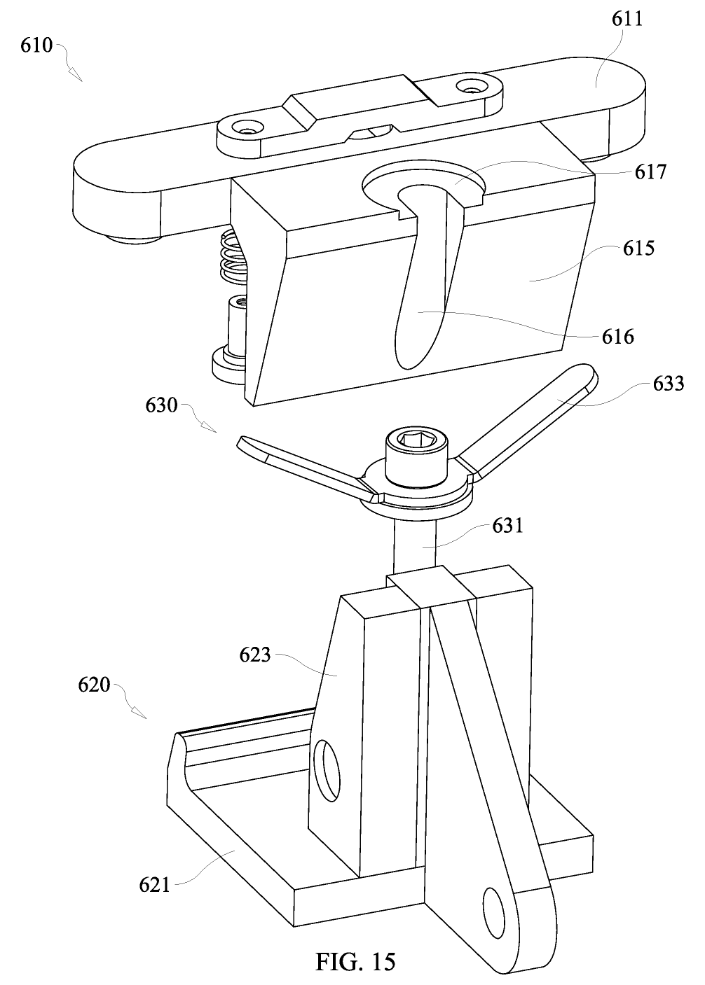

Referring to FIG. 15, the first vertical part 615 of the first member 610 further comprises a recess 616 and a lip 617. When the first member 610 is coupled to the second member 620, the recess 616 receives the rod 631, and the annular flange 632 is seated on the lip 617.

With continuing reference to FIGS. 14-15, FIG. 16 shows that the second member 620 further comprises a longitudinal protrusion 622 corresponding to the groove 578 of the frames 516. The protrusion 622 extends from a top surface of the second horizontal part 621 of the second member 620 towards the first horizontal part 611 of the first member 610. The groove 578 of the frame 516 is configured to receive the protrusion 622 of the second member 620, and the track 530 of the frame 516 is configured to receive the stud(s) 612 of the first member 610. To couple the fastening joint 600 to the body 510, the rod 631 may be screwed downwards towards the second member 620, and the flange 632 urges against the lip 617, thereby decreasing a distance between the first member 610 and the second member 620 until the fastening joint 600 is securely fastened to the body 510. To decouple the fastening joint 600 from the body 510, the rod 631 may be unscrewed upwards towards the first member 610, and the flange 632 departs away from the lip 617, thereby increasing a distance between the first member 610 and the second member 620 until the fastening joint 600 may be detached from the body 510.

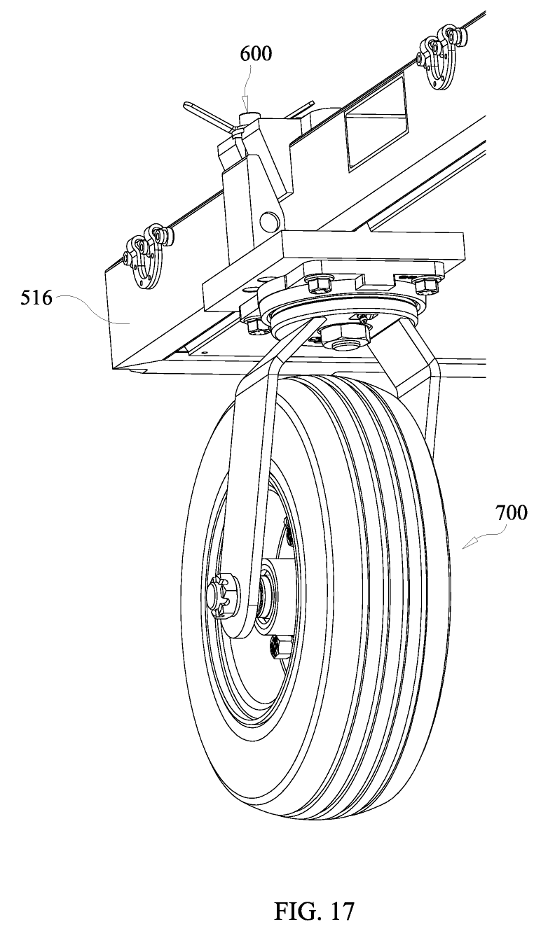

Referring to FIG. 17 and in conjunction with FIG. 9, the fastening joint 200 may be utilized on accessories, such as a plurality of caters 700 and a tow bar 800. As shown in FIG. 9, the fastening joint 600 may further comprise a linking member 640 to secure the tow bar 800 to two fastening joints 600. By comparison, as shown in FIG. 17, the caster 700 may be secured to the fastening joint 600, (specifically to the second horizontal part 621 of the second member 620, which is not shown in FIG. 17). As a result, the casters 700 (and also the tow bar 800) may be easily coupled and decoupled to the body 510 of the transport pallet 500.

An exemplary method of coupling and decoupling the fastening joint 600 is presented herein to further demonstrate the convenience and efficiency of the second exemplary embodiment. It is anticipated that several steps may be sequentially interchangeable and equivalent application of one or more permutations of such sequentially interchangeable steps does not alter the spirit of the present disclosure in any meaningful way. It is noted that not all methods are required, and not all method steps are presented herein.

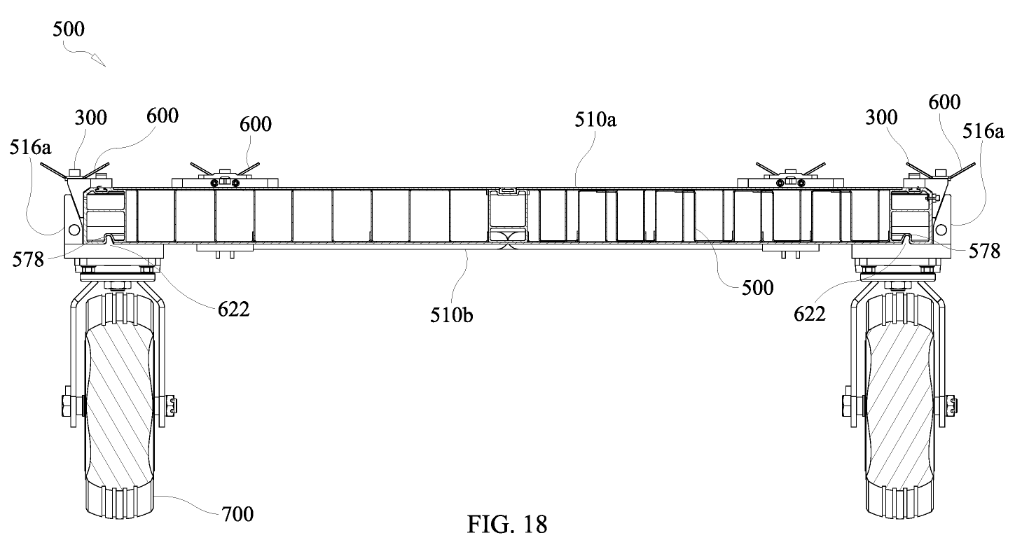

Referring to FIGS. 18 and in conjunction with FIGS. 14 to 16, to couple an accessory to the transport pallet 500, an exemplary user first joins the protrusion 622 on the second member 620 to the groove 578 on the bottom surface 510b of the body 510 and inserts the at least one stud 612 on the first member 610 into the track 530 on the top surface 510a of the body 510. Next, the exemplary user holds on to the at least one lever 633 and screws the connecting member 630 towards the second member 620 until the fastening joint 600 is securely locked to the transport pallet 500.

To decouple the accessory from the transport pallet 500, the exemplary user simply unscrews the connecting member 630 away from the second member 620 until the fastening joint 600 is loose enough to be removed.

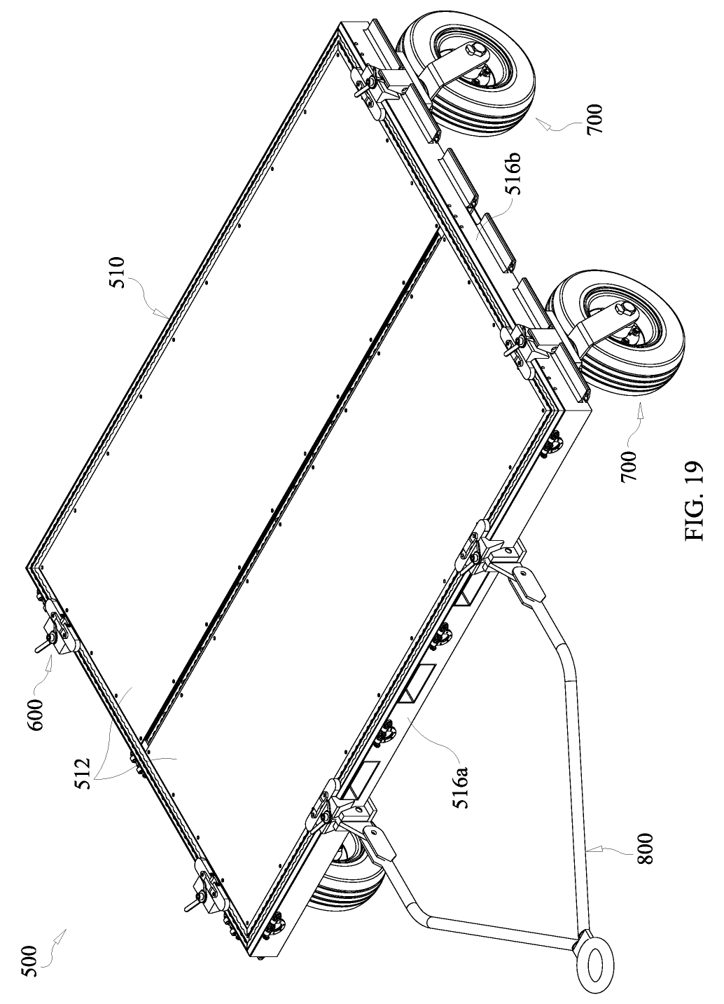

Referring to FIG. 19, the exemplary user may simply decouple the accessories from the transport pallet 500 and rearrange them relative to the transport pallet 500. As shown in FIG. 19, the tow bar 800 is alternatively coupled to one of the two first frames 516a and the four casters 700 are coupled to the two second frames 516b. Advantageously, the transport pallet may be towed in a direction different from FIG. 9, as compared to FIG. 19.

While the embodiments of the invention have been disclosed, certain modifications may be made by those skilled in the art to modify the invention without departing from the spirit of the invention.

1. A transport pallet, comprising:
a body having a first surface, an opposing second surface and a plurality of side surfaces;
wherein at least one side surface of the plurality of side surfaces includes at least one opening;
a plurality of internal support structures arranged in spaced-apart columns and disposed between the first surface and the second surface; and
wherein adjacent columns of the spaced-apart columns are separated by a gap in communication with the at least one opening.

2. The transport pallet of claim 1, wherein each internal support structure of the plurality of internal support structures comprises a plurality of continuous ridges and grooves.

3. The transport pallet of claim 2, wherein the continuous ridges and grooves have a rectangular prism configuration.

4. The transport pallet of claim 2, wherein the continuous ridges and grooves are disposed parallel to a length of the body.

5. The transport pallet of claim 1, wherein the at least one opening comprises two openings.

6. The transport pallet of claim 1, further comprising:
a plurality of casters, wherein each of the casters comprises a caster fastening mechanism configured to couple each of the casters to the body.

7. The transport pallet of claim 6, wherein each caster of the plurality of casters comprises a first through hole, and the body comprises at least one second through hole configured for alignment with the first through hole of a corresponding caster; and wherein the first fastening mechanism is configured to be inserted into the first through hole and the at least one second through hole to lock each of the casters to the body.

8. The transport pallet of claim 7, wherein each caster of the plurality of casters includes the first through hole positioned on a protrusion disposed thereon, and wherein the bottom surface of the body comprises a plurality of sockets, each socket configured to receive the corresponding protrusion of a corresponding casters.

9. The transport pallet of claim 1, wherein the top surface comprises at least one track disposed along a periphery thereof.

10. The transport pallet of claim 9, further comprising a tow bar configured for coupling to the at least one track by a tow bar fastening mechanism.

11. A transport pallet, comprising:
a body comprising at least one top plate, an opposing bottom plate, and a plurality of frames forming boundaries to couple the at least one top plate to the bottom plate;
wherein at least one of the plurality of frames comprises at least one opening;
a plurality of internal support structures arranged in spaced-apart rows and disposed between the at least one top plate and the bottom plate;
wherein adjacent rows of the spaced apart rows are separated by a gap, and each of the plurality of spaced apart rows comprises a plurality of continuous ridges and grooves; and
wherein the gap is in communication with the at least one opening.

12. The transport pallet of claim 11, wherein the plurality of frames includes five frames, and wherein four frames of the plurality of frames form a rectangular periphery, and the remaining frame of the plurality of frames is positioned parallel to two frames of the plurality of frames and perpendicular to two other frames of the plurality of frames.

13. The transport pallet of claim 11, wherein the at least one opening comprises two openings.

14. The transport pallet of claim 11, further comprising a plurality of casters, wherein each of the casters comprises a caster fastening mechanism configured for coupling each of the casters to the body.

15. The transport pallet of claim 14, wherein each caster of the plurality of casters comprises a first through hole, and the body comprises at least one second through hole configured for alignment with the first through hole of a corresponding caster; and wherein the first fastening mechanism is configured to be inserted into the first through hole and the at least one second through hole to lock caster of the plurality of casters to the body.

16. The transport pallet of claim 15, wherein each caster of the plurality of casters includes the first through hole positioned on a protrusion disposed thereon, and wherein the bottom surface of the body comprises a plurality of sockets, each socket configured to receive the corresponding protrusion of a corresponding casters.

17. The transport pallet of claim 11, further comprising at least one track positioned on a top surface of at least one of the plurality of frames.

18. The transport pallet of claim 17, further comprising a tow bar configured for coupling to the at least one track by a two bar fastening mechanism.

19. A transport pallet, comprising:
a body comprising at least one top plate, an opposing bottom plate, and a plurality of frames configured to couple the at least one top plate to the bottom plate;
wherein at least one of the plurality of frames comprises at least one opening;
a plurality of internal support structures arranged in spaced-apart rows and disposed between the at least one top plate and the bottom plate;
at least one opening extending from one of the frames of the plurality of frames to an opposing frame of the plurality of frames, the at least one opening configured to divide the plurality of internal support structures into at least two columns.

20. The transport pallet of claim 19, wherein the at least one opening comprises two openings, the two openings being configured to divide the plurality of internal support structures into at least three columns and configured to receive an associated fork lift.
